(19) United States
(12) Patent Application Publication
(10) Pub. No.: US 2013/0078591 A1
(43) Pub. Date: Mar. 28, 2013

(54) Anti-scald protection apparatus for air heater

(71) Applicant: Chia Hao Chang, Tainan (TW)

(72) Inventor: Chia Hao Chang, Tainan (TW)

(21) Appl. No.: 13/200,253

(22) Filed: Sep. 22, 2011

(51) Int. Cl. F27D 5/00

(52) U.S. Cl. 432/250

(57) ABSTRACT

The present invention relates to an anti-scald protection apparatus for an air heater having a grid anti-scald cover installed and fixed in front of a wind outlet net in front of a wind outlet of the air heater, and a distance is maintained between the anti-scald cover and the wind outlet net to protect users from being burned by touching the wind outlet net accidentally and achieve a safety protection effect.

### BACKGROUND OF THE INVENTION

1. Field of the Invention

The present invention relates to an anti-scald protection apparatus for an air heater, and more particularly to the anti-scald protection apparatus having a grid anti-scald cover installed and fixed at position with a predetermined distance from the front of a hot air outlet of the air heater for preventing users from being burned by touching the high-temperature wind outlet net in front of the wind outlet.

2. Description of the Related Art

In general, an air heater includes a fan and an electric heater (such as a heater with a positive temperature coefficient), and the fan blows the heat generated by the electric heater out from a wind outlet to provide hot winds or even far infrared to users. With reference to FIG. 1 for a conventional air heater 1, a heat resistant grid wind outlet net 11 is installed at a position of the wind outlet 10 to prevent a user's fingers or skin from being burned by touching the electric heater accidentally. However, the wind outlet net 11 will accumulate heat continuously during the operation of the air heater 1, and the wind outlet net 11 is situated at the outermost side of the air heater 1, so that once the wind outlet net 11 is touched, the user's fingers or skin may be burned. In view of this problem, the inventor of the present invention designed and developed an anti-scald protection apparatus in accordance with the present invention.

### SUMMARY OF THE INVENTION

Therefore, it is a primary objective of the present invention to provide an anti-scald protection apparatus for an air heater capable of preventing users from being burned by touching the wind outlet net at the position of a wind outlet accidentally. The present invention is characterized in that a grid anti-scald cover is installed and fixed in front of the wind outlet net of the wind outlet of the air heater, and a predetermined distance is maintained between the anti-scald cover and the wind outlet net for preventing users from being burned by touching the wind outlet net accidentally and achieving a safety protection effect.

### BRIEF DESCRIPTION OF THE DRAWINGS

FIG. 1 is a perspective view of a conventional air heater

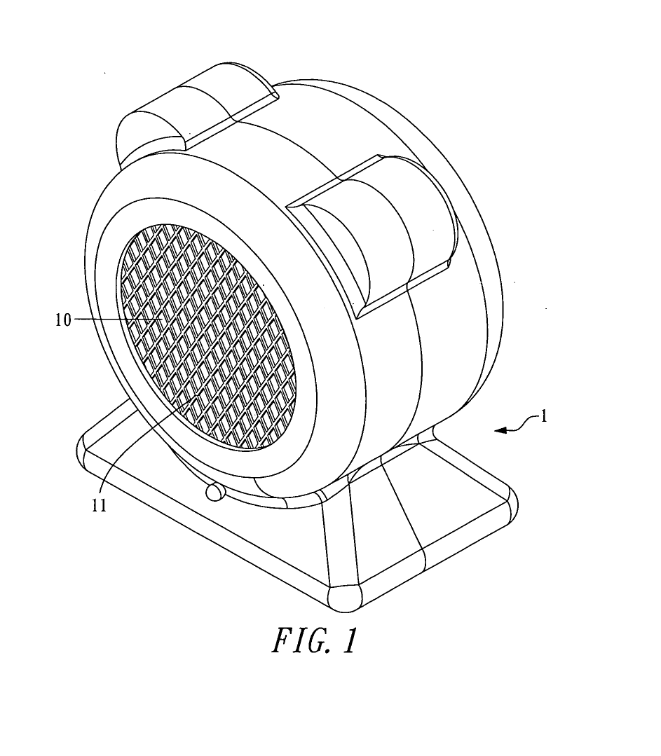

FIG. 2 is a perspective view of a first preferred embodiment of the invention;

FIG. 3 is an exploded view of the first preferred embodiment of the invention;

FIG. 4 is a cross-sectional view of the first preferred embodiment of the invention;

FIG. 5 is a perspective view of a second preferred embodiment of the invention;

FIG. 6 is an exploded view of the second preferred embodiment of the invention; and

FIG. 7 is a cross-sectional view of the second preferred embodiment of the invention.

### DETAILED DESCRIPTION OF THE PREFERRED EMBODIMENTS

The technical characteristics and effects of the present invention will become apparent with the detailed description of preferred embodiments accompanied with the illustration of related drawings of the present invention as follows.

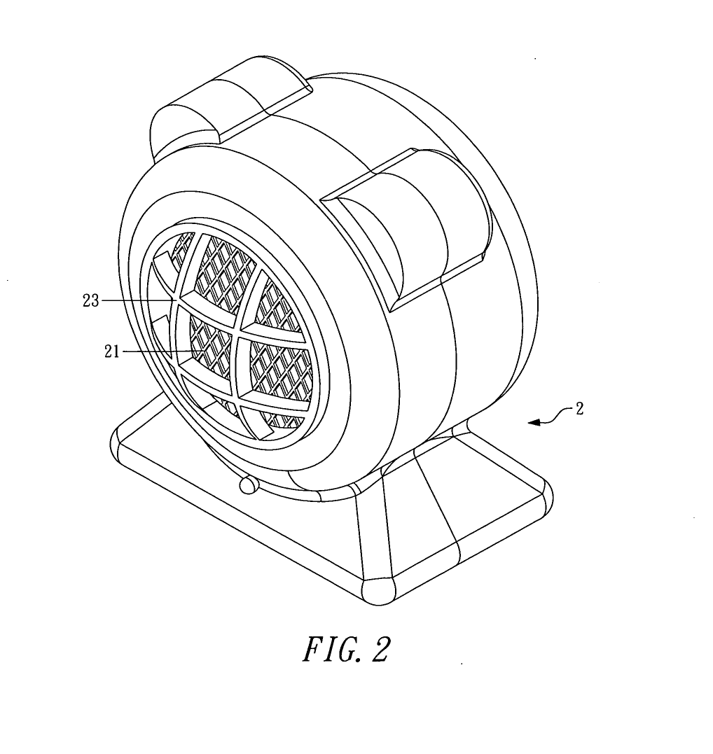

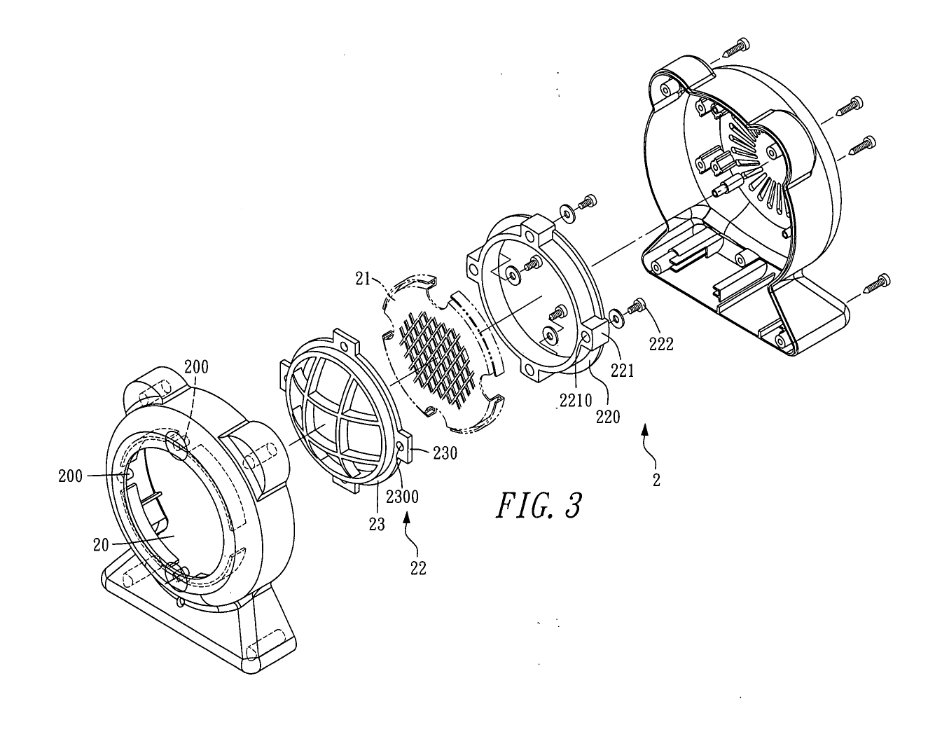

With reference to FIGS. 2 to 4 for an air heater 2 in accordance with the first preferred embodiment of the present invention, the air heater 2 comprises conventional fan and electric heater (not shown in the figures), a grid wind outlet net 21 installed at a front end of the wind outlet 20, wind outlet 20 for preventing a user's fingers from stretching from the wind outlet 20 into the electric heater and getting hurt.

The anti-scald protection apparatus of the invention comprises: an anti-scald cover 23 in a cambered shape fixed to a front side of the wind outlet net 21 by a fixing structure 22, wherein the anti-scald cover 23 is made of heat-resistant silicone or any other heat resistant material. A predetermined distance is maintained between the middle of the anti-scald cover 23 and the wind outlet net 21. The anti-scald cover 23 installed on the front side of the high-temperature wind outlet net 21 can prevent users from being burned by touching the wind outlet net 21 accidentally.

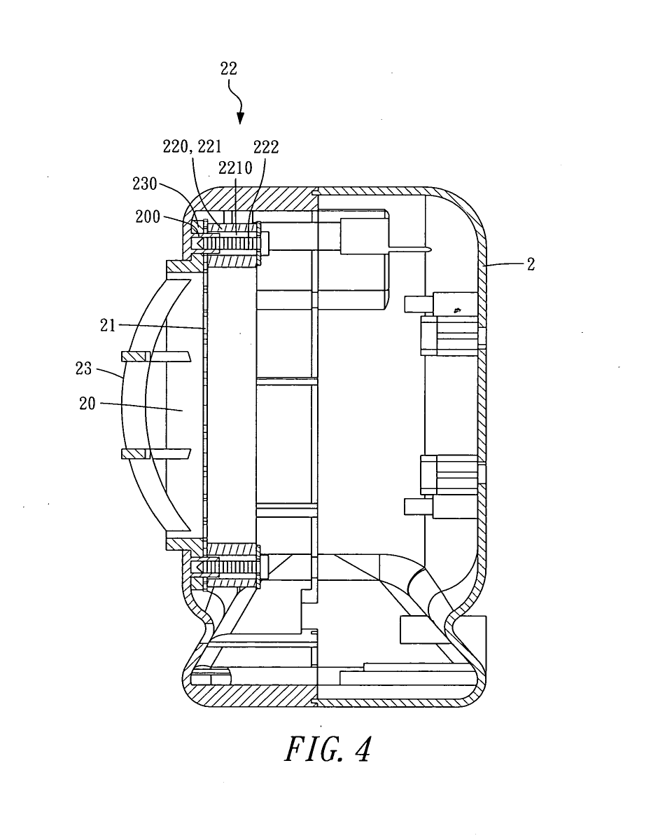

The fixing structure 22 for fixing the anti-scald cover 23 has a fixing wing 230 protruded separately from four corners of the anti-scald cover 23, and each fixing wing 230 has a through hole 2300 formed at the middle of the fixing wing 230. A housing of the air heater 2 is disposed on an internal side of the wind outlet 20 and a screw column 200 having a screw hole is matched with the through hole 2300 of the fixing wing 230 of the anti-scald cover 23 and the screw column 200 can pass through the through hole 2300 of the fixing wing 230 of the anti-scald cover 23 for embedding the anti-scald cover 23 to temporarily. A press block 221 having a press ring 220 is disposed at a rear side of the wind outlet net 21 and at a position corresponding to each screw column 200, and the press block 221 has a penetrating hole 2210 for embedding the screw column 200, and a screw 222 is extended into the penetrating hole 2210 and secured to the screw hole of the screw column 200, so that the press ring 220 can abut the external peripheries of the wind outlet net 21 and the anti-scald cover 23 against the internal side of the wind outlet 20 simultaneously. The anti-scald cover 23 has a cambered shape and is extended to the outside from the wind outlet 20, and a distance is maintained between the middle position and the wind outlet net 21 to prevent users from being burned by touching the high-temperature wind outlet net 21 accidentally as shown in FIG. 4.

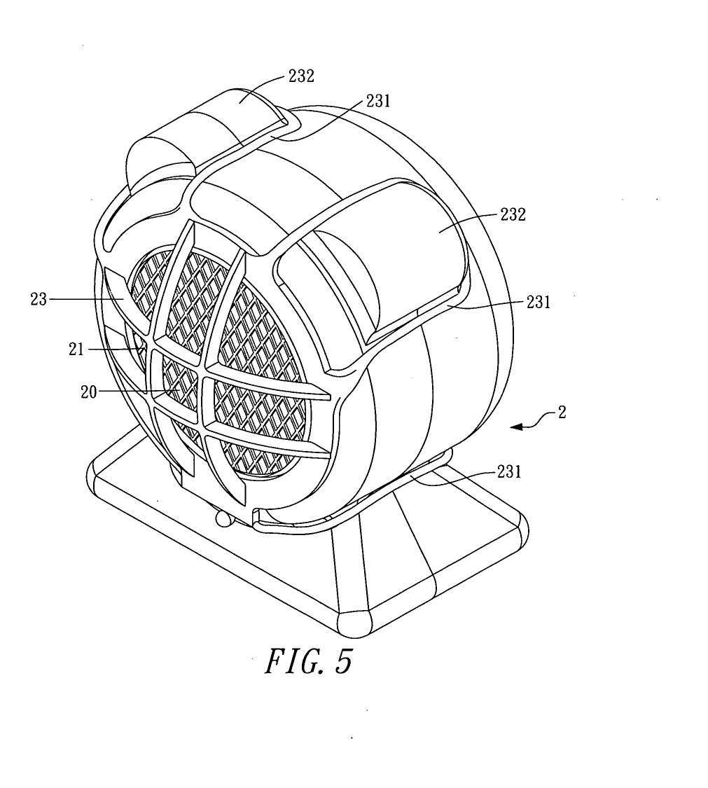

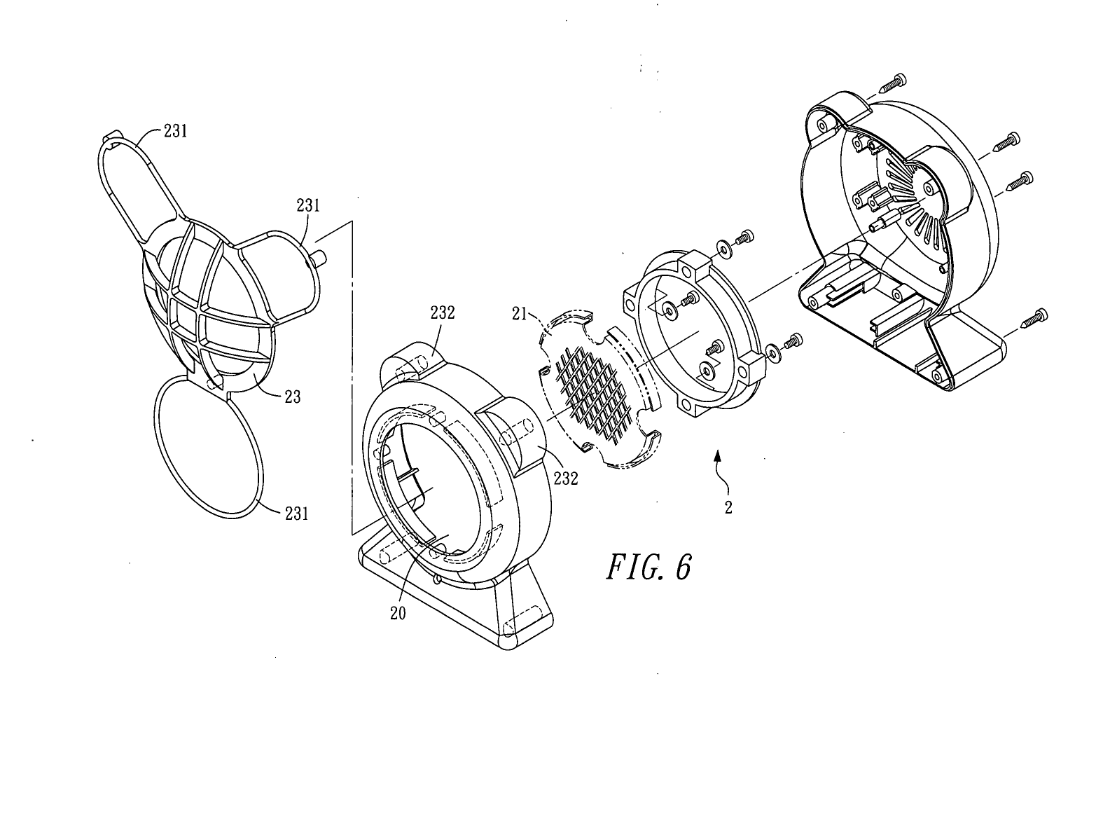

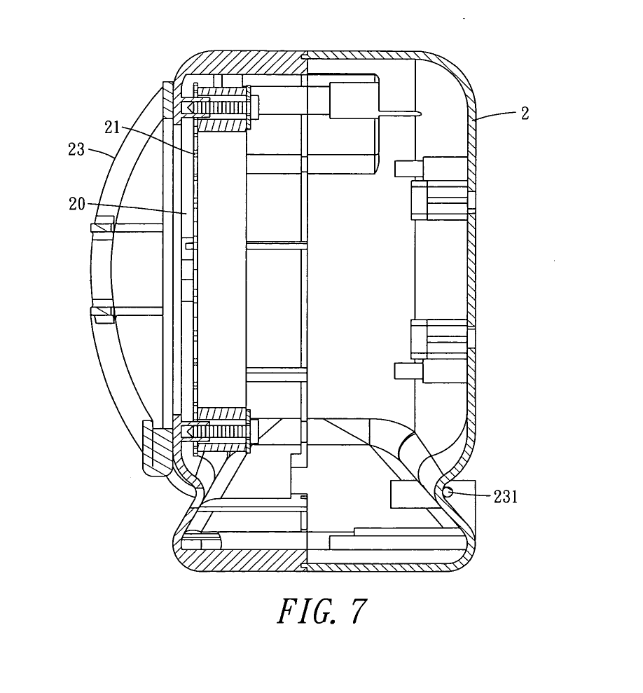

With reference to FIGS. 5 to 7, a fixing structure is provided for fixing the anti-scald cover 23 at the front end of the wind outlet 20, and a fixing lug 231 is installed at the periphery of the anti-scald cover 23. When the anti-scald cover 23 is fixed, the anti-scald cover 23 is attached to the front of the wind outlet 20, and the fixing lug 231 is pulled backward to latch any externally protruding fixing object 232 of the air heater 2 for fixing the anti-scald cover 23, and a preferred distance is maintained between the anti-scald cover 23 and the wind outlet net 21 for protecting users, and preventing users from being burned by touching the high-temperature wind outlet net 21 accidentally.

In summation of the description above, the anti-scald cover 23 of the present invention is installed at a front side of the high-temperature wind outlet net 21, and a predetermined distance is maintained between the anti-scald cover 23 and the wind outlet net 21 to prevent users from touching the wind outlet net 21 installed in front of the electric air heater, so as to provide a protection effect.

In summation of the description above, the present invention improves over the prior art and complies with the patent application requirements, and is thus duly filed for patent application.

What is claimed is:

1. An anti-scald protection apparatus for an air heater, characterized in that a grid anti-scald cover is fixed in front of a wind outlet net of a wind outlet of the air heater by a fixing structure, and a predetermined distance is maintained between the anti-scald cover and the wind outlet net.

2. The anti-scald protection apparatus for an air heater as recited in claim 1, wherein the anti-scald cover has a cambered shape.

3. The anti-scald protection apparatus for an air heater as recited in claim 1, wherein the anti-scald cover is made of heat-resistant silicone.

4. The anti-scald protection apparatus for an air heater as recited in claim 1, 2 or 3, wherein the fixing structure comprises: a fixing wing, protruded separately from four corners of the anti-scald cover, and having a through hole formed at the middle of each fixing wing; a casing of the air heater being disposed on an internal side of the wind outlet; a screw column having a screw hole formed in the middle of the screw column and matched with the through hole of the fixing wing of the anti-scald cover for passing through the through hole of the anti-scald cover fixing wing; a press ring disposed on a backside of the wind outlet net; a press block protruded from the periphery and at a position corresponding to each screw column, and the press block having a penetrating hole for embedding the screw column, and a screw being extended into the penetrating hole and secured into the screw hole of the screw column, so that the press ring abuts the external peripheries of the wind outlet net and the anti-scald cover against an internal side of the wind outlet, and a predetermined distance being maintained between the middle position of the anti-scald cover and the wind outlet net.

5. The anti-scald protection apparatus for an air heater as recited in claim 1, 2 or 3, wherein the fixing structure comprises a fixing lug disposed at the periphery of the anti-scald cover, such that when the anti-scald cover is fixed, the anti-scald cover is attached to the front of the wind outlet, and the fixing lug is pulled backward and fixed onto a protruding fixing object of the air heater for fixing the anti-scald cover, and a predetermined distance is maintained between the anti-scald cover and the wind outlet net.
